(19) United States
(12) Patent Application Publication
(10) Pub. No.: US 2003/0131360 A1
(43) Pub. Date: Jul. 10, 2003

(54) Interfacing system for stream source device and display apparatus and interfacing method thereof

(76) Inventors: Chul Yong Joung, Seoul (KR); Nam Seok Cho, Ohsan (KR)

Correspondence Address: BIRCH STEWART KOLASCH & BIRCH, PO BOX 747, FALLS CHURCH, VA, 22040-0747, US

(21) Appl. No.: 10/338,751

(22) Filed: Jan. 9, 2003

(30) Foreign Application Priority Data
Jan. 10, 2002 (KR) 01365/2002

(51) Int. Cl. H04N 7/173; H04N 7/18

(52) U.S. Cl. 725/118; 725/81; 725/91; 725/92; 725/98; 725/114; 348/734

(57) ABSTRACT

Disclosed are an interface system for stream source and display devices and an interfacing method thereof. The present invention includes a stream source device receiving analog/digital signals from external analog/digital equipments to generate a transmission packet stream corresponding to the analog/digital signal and transmitting the transmission packet stream by wireless and a display device receiving the transmission packet stream transmitted from the stream source device, the display device decoding the transmission packet stream to separate into a video signal and an audio signal to output respectively. Therefore, the present invention needs no additional cables to transmit various video, audio, and various control signals between the stream source and display devices, thereby enabling to overcome the problem of defiling the appearance of the cables exposed on the wall.

This application claims the benefit of the Korean Patent Application No. P2002-01365 filed on Jan. 10, 2002, which is hereby incorporated by reference.

### BACKGROUND OF THE INVENTION

1. Field of the Invention

The present invention relates to an interface system for source and display devices and an interfacing method thereof, and more particularly, to an interface system for stream source and display devices and an interfacing method thereof enabling to transmit/receive transmission packet streams and various radio control signals between the stream source and display devices by wireless.

2. Description of the Related Art

Recent electronic technology developments contribute to the developments of various flat panels display (FPD) devices. In a display device such as a TV screen and a monitor, the flat panel display device replaces a cathode ray tube due to its features and advantages of lightweight, thin design, and the like to employ as a display screen for representing a predetermined image.

A plasma display panel (PDP) using photo-luminescence (PL) as a florescent material, a field emission display device (FED) using cathode luminescence (CL), a liquid crystal display device (LCD), an organic electroluminescent display device, and the like are employed as flat panel display devices in various fields.

In such flat panel display devices, the PDP has such features and advantages as high brightness, high luminescence ratio, low unit cost of production, excellent characteristics of heat & cold resistance, feasibility of full color implementation, and lightweight. Hence, the PDP is equipped with a large size screen and is widely used as a display screen for a display device for TV set, computer monitor, or the like.

Moreover, the display device used as the display screen of the PDP has the feature and advantage of thin design and lightweight, thereby being under development for a wall TV.

The display device using the PDP receives video and audio signals from a stream source device such as a set-top box to output video and audio. For this purpose, the display and stream source devices according to the related art are constructed to transmit/receive the video and audio signals of the stream source device through a wire as well as transmit/receive a predetermined control signal through the wire.

FIG. 1 illustrates a diagram of an interface system for stream source and display devices according to a related art.

Referring to FIG. 1, an interface system for a stream source device and a display device, like a wall monitor or a wall TV, includes a wall display device 10 using a PDP as a display screen, a digital unit 20 outputting a transmission packet stream corresponding to digital video and audio signals by playing a predetermined play media such as a digital VTR (video tape recorder), a DVD (digital versatile disc) player, or the like, an analog unit 30 outputting analog video and audio signals like a VTR, a computer system, or the like by playing a play media such as video tape or the like, and a stream source device 40 receiving a digital broadcast signal as well as the transmission packet stream outputted from the digital unit 20 and the analog video and audio signals outputted from the analog unit 30 to switch selectively like a set-top box, the stream source device 40 transmitting the switched signals to the display device 10.

In the interface system, the digital unit 20 is connected to the source stream source device through a wire such as IEEE 1394 cable.

The interface system for the above-constructed display and stream source devices according to a related art is explained in detail as follows.

First of all, the digital unit 20 formats the digital video and audio signals attained by playing the predetermined play media into the transmission packet stream to output, and the outputted transmission packet stream is transmitted to the stream device 40 through the wire such as IEEE 1394 cable.

Meanwhile, the analog unit 30 plays the predetermined play media to generate the analog video and audio signals, and then transmits the generated analog video signals such as R/G/B signals and the analog audio signals to the stream source device 40 through the wire. In this case, the analog unit 30 is connected to the stream source device 40 through an exclusive cable.

The stream source device 40 directly receives the digital broadcast signal through a built-in ATSC tuner or the like. In this case, the received digital broadcast signal includes the transmission packet stream corresponding to the digital video and audio signals.

Moreover, the stream source device 40 transforms the transmission packet stream inputted from the digital unit 20 into the analog video and audio signals, switches the transformed analog video and audio signals or the inputted analog video and audio signals transmitted from the analog unit 30 selectively, and transmits the switched analog video and audio signals to the display device 10.

In this case, the stream source device 40 transmits the analog R/G/B signals and audio signals of L and R channels to the display device 10 through the respective cables or a single exclusive cable. Moreover, the display and stream source devices 10 and 40 are connected to each other through an additional cable for control/response signals to transmit/receive a predetermined control signal and a response signal according to the control signal reciprocally.

However, connected to the various units through the wire(s), the display device requires a plurality of input terminals.

Moreover, when the display device connected to the stream source device through the predetermined cable is hung on a wall, the cable is exposed between the display device and the stream source device to defile the appearance of installation.

### SUMMARY OF THE INVENTION

Accordingly, the present invention is directed to an interface system for stream source and display devices and an interfacing method thereof that substantially obviate one or more problems due to limitations and disadvantages of the related art.

An object of the present invention is to provide an interface system for stream source and display devices which transforms video and audio signals into a transmission packet stream form to transmit to a display device by wireless.

Another object of the present invention is to provide a display device which receives video and audio signals of a transmission packet stream transmitted from a stream source device by wireless to display on a screen.

A further object of the present invention is to provide an interfacing method for stream source and display devices enabling to have the stream source device carry out a corresponding operation according to a remote control signal by having the display device receive the remote control signal by a remote controller and having the display device transmit the received remote control signal to the stream source device by wireless.

Another further object of the present invention is to provide an interface system for stream source and display devices and interfacing method thereof enabling the stream source device to transmit a transmission packet stream of video and audio signals by wireless and enabling the display device to receive to process the transmission packet stream transmitted by wireless.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an interface system for a stream source device and a display device according to the present invention includes a stream source device 100 receiving analog/digital signals from external analog/digital equipments to generate a transmission packet stream corresponding to the analog/digital signal and transmitting the transmission packet stream by wireless and a display device 200 receiving the transmission packet stream transmitted from the stream source device 100, the display device decoding the transmission packet stream to separate into a video signal and an audio signal to output respectively.

Preferably, the stream source device 100 includes a transmission packet stream generating unit 120 receiving a digital broad cast signal, a digital signal, or an analog signal to format into a form of a transmission packet stream to output selectively, a transmission packet stream processing unit 130 processing the transmission packet stream generated from the transmission packet stream generating unit 120, a memory 140 storing the transmission packet stream processed by the transmission packet stream processing unit 130, a wireless transmitting/receiving unit 150 reading to transmit the transmission packet stream stored in the memory by wireless, and a central processing unit 110 controlling a predetermined operation for transmitting the transmission packet stream and operations of the respective units.

Preferably, the display device includes a wireless transmitting/receiving unit 230 receiving the transmission packet stream transmitted from the stream source device 100, a memory 240 storing the transmission packet stream received from the wireless transmitting/receiving unit 230, a transmission packet stream processing unit 250 processing the transmission packet stream stored in the memory 240, a decoder 260 decoding the transmission packet stream processed by the transmission packet stream processing unit 250 to separate into a video signal and an audio signal, a video processor 270 processing to output the video signal separated by the decoder 260, an audio processor 280 processing to output the audio signal separated by the decoder 260, and a central processing unit 210 controlling a predetermined operation for receiving to process the transmission packet stream.

In another aspect of the present invention, a stream source device includes a transmission packet stream generating unit 120 receiving a digital broad cast signal, a digital signal, or an analog signal to format into a form of a transmission packet stream to output selectively, a transmission packet stream processing unit 130 processing the transmission packet stream generated from the transmission packet stream generating unit 120, a memory 140 storing the transmission packet stream processed by the transmission packet stream processing unit 130, a wireless transmitting/receiving unit 150 reading to transmit the transmission packet stream stored in the memory by wireless, and a central processing unit 110 controlling a predetermined operation for transmitting the transmission packet stream and operations of the respective units.

In a further aspect of the present invention, a display device includes a wireless transmitting/receiving unit 230 receiving a transmission packet stream transmitted from a stream source device 100, a memory 240 storing the transmission packet stream received from the wireless transmitting/receiving unit 230, a transmission packet stream processing unit 250 processing the transmission packet stream stored in the memory 240, a decoder 260 decoding the transmission packet stream processed by the transmission packet stream processing unit 250 to separate into a video signal and an audio signal, a video processor 270 processing to output the video signal separated by the decoder 260, an audio processor 280 processing to output the audio signal separated by the decoder 260, and a central processing unit 210 controlling a predetermined operation for receiving to process the transmission packet stream.

In another further aspect of the present invention, an interfacing method for stream source and display devices includes a judging step of judging whether a remote control signal inputted to a display device in accordance with a user's remote controller operation is a signal for controlling an operation of a stream source device or the display device, a performing step of having the display device carry out a corresponding operation according to the inputted remote control signal if the judging step judges that the remote control signal is the signal for controlling the operation of the display device, a transmitting step of having the display device transmit the inputted remote control signal by wireless to the stream source device if the judging step judges that the remote control signal is the signal of controlling the operation of the stream source device, and a step of having the stream source device receive the remote control signal transmitted by wireless to carry out the corresponding operation.

Preferably, the method further includes a step of having the stream source device carry out the operation according to the remote control signal transmitted by wireless, having the stream source device generate a response signal for informing that the remote control signal is normally received, and having the stream source device transmit the response signal to the display device by wireless.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 illustrates a diagram of an interface system for stream source and display devices according to a related art;

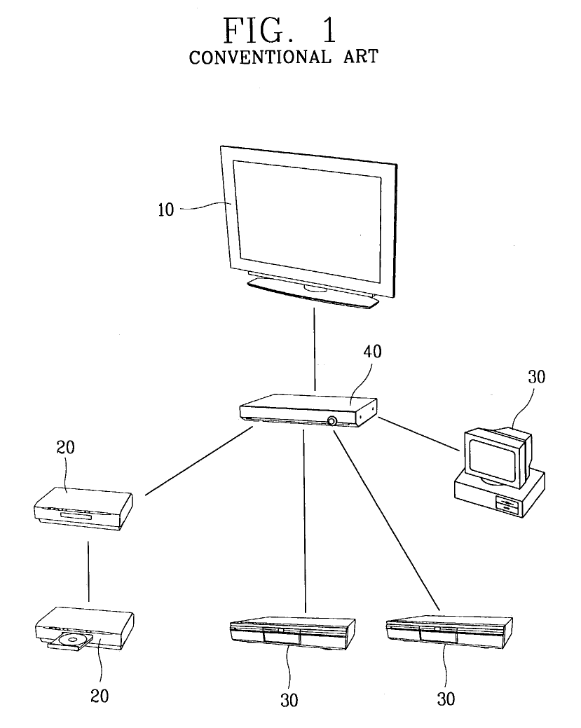

FIG. 2 illustrates a block diagram of a stream source device according to the present invention;

FIG. 3 illustrates a block diagram of a display device according to the present invention; and

FIG. 4 illustrates a signal flowchart of operating a central processing unit built in a display device according to the present invention.

### DETAILED DESCRIPTION OF THE INVENTION

Reference will now be made in detail to the preferred embodiments of the present invention, examples of which are illustrated in the accompanying drawings.

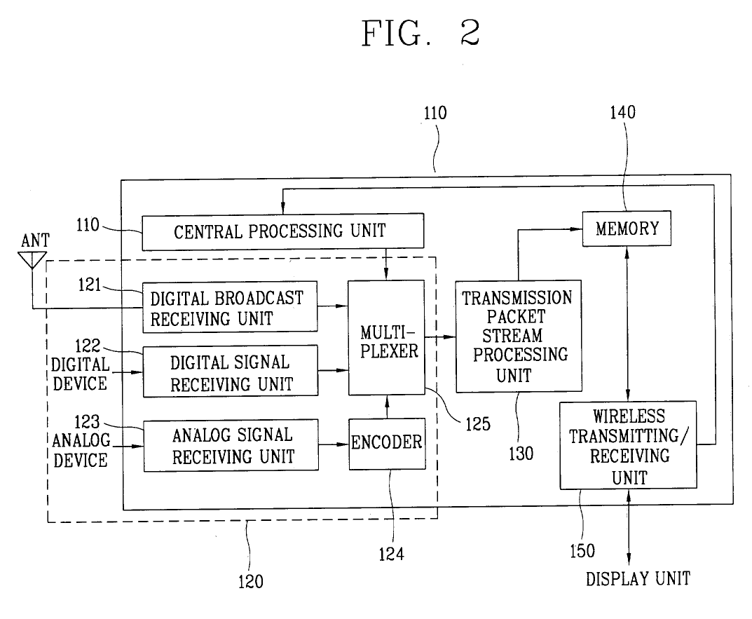

FIG. 2 illustrates a block diagram of a stream source device 100 according to the present invention.

Referring to FIG. 2, a stream source device 100 according to the present invention includes a central processing unit 110 controlling a series of operation for transmitting a transmission packet stream corresponding to video and audio signals to a display device 200, the central processing unit 100 controlling an operation of the stream source device 100 according to a remote control signal, which is received from the display device 200, by a remote controller and simultaneously generating a response signal according to the received remote control signal to transmit to the display device 200 by wireless, a transmission packet stream generating unit 120 generating the transmission packet stream corresponding to the inputted video and audio signals, a transmission packet stream processing unit 130 processing the transmission packet stream generated from the transmission packet stream generating unit 120, a memory 140 storing the transmission packet stream processed by the transmission packet stream processing unit 130, and a wireless transmitting/receiving unit 150 reading to transmit the transmission packet stream stored in the memory 140 and simultaneously transmitting/receiving a predetermined control signal and a response signal by wireless.

In this case, the transmission packet stream generating unit 120 includes a digital broadcast receiving unit 121 having an ATSC(advanced television systems committee) tuner, a VSB(vestigial side band) chip, and the like to receive a digital broad cast signal through an external antenna ANT, the digital broadcast receiving unit 121 transforming the received digital broadcast signal into a transmission packet stream form to output, a digital signal receiving unit 122 receiving a transmission packet stream corresponding to digital video and audio signals from an external digital equipment to output, an analog signal receiving unit 123 receiving analog video and audio signals from an external analog equipment to output, an encoder 124 transforming the analog video and audio signals outputted from the analog signal receiving unit 123 into a transmission packet stream form, and a multiplexer 125 selectively switching the transmission packet streams outputted from the digital broadcast receiving unit 121, digital signal receiving unit 122, and encoder 124 according to a control of the central processing unit 110 to output to the transmission packet stream processing unit 130.

Moreover, in the digital broadcast receiving unit 121 of the transmission packet stream generating unit 120, the built-in ATSC tuner receives the digital broadcast signal and the built-in VSB chip transforms the received digital broadcast signal into the transmission packet stream form to output to the multiplexer 125.

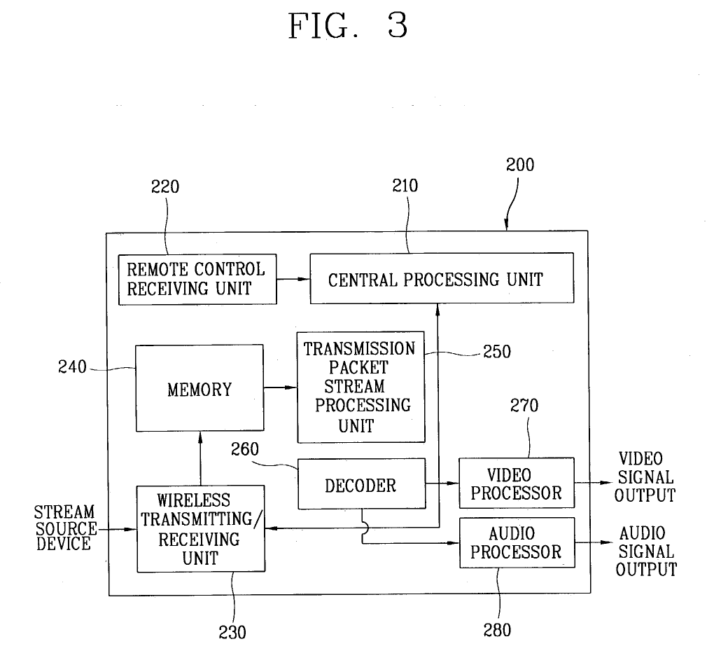

FIG. 3 illustrates a block diagram of a display device 200 according to the present invention.

Referring to FIG. 3, a display device 200 according to the present invention includes a central processing unit 210 controlling a series of operation of receiving to process the transmission packet stream transmitted by wireless from the stream source device 100 and judging a remote control signal received by a remote control receiving unit 220, the central processing unit 210 transmitting the remote control signal to the stream source device 100 by wireless if the remote control signal is a signal for controlling an operation of the stream source device 100 or controlling the display device 200 to carry out a corresponding operation according to the remote control signal if the remote control signal is for controlling a predetermined operation of the display device 200, a wireless transmitting/receiving unit 230 receiving to input the transmission packet stream transmitted by wireless from the stream source device 100 and a response signal corresponding to the remote control signal by the remote control receiving unit 220 to the central processing unit 210, a memory 240 storing the transmission packet stream received from the wireless transmitting/receiving unit 230, a transmission packet stream processing unit 250 reading to process the transmission packet stream stored in the memory, a decoder 260 decoding the transmission packet stream processed by the transmission packet stream processing unit 250 to separate into a video signal and an audio signal, a video processor 270 processing to output the video signal separated by the decoder 260, and an audio processor 280 processing to output the audio signal separated by the decoder 260.

An interface system for stream source and display devices and an interfacing method thereof according to the present invention are explained in detail by referring to the attached drawings of FIG. 2 and FIG. 3 as follows.

First of all, the digital broadcast receiving unit 121 of the transmission packet stream generating unit 120 receives the digital broadcast signal of a predetermined channel from the external antenna ANT using the built-in ATSC tuner, and then the built-in VSB chip or the like transforms the received digital broadcast signal into the transmission packet stream form to output to the multiplexer 125.

Moreover, the digital signal receiving unit 122 of the transmission packet stream generating unit 120 receives the transmission packet stream corresponding to the digital video and audio signals transmitted from the external digital equipment and then outputs the received transmission packet stream to the multiplexer 125.

Meanwhile, the analog signal receiving unit 123 of the transmission packet stream generating unit 120 receives the analog video and audio signals transmitted from the external analog equipment, and then transforms the received analog video and audio signals into the transmission packet stream form corresponding to digital video and audio signals to output to the multiplexer 125.

Subsequently, the multiplexer 125 switches the transmission packet streams inputted from the digital broadcast receiving unit 121, digital signal receiving unit 122, and encoder 124 respectively in accordance with the control of the central processing unit 110 to select one of the transmission packet streams.

And, the transmission packet stream processing unit 130 receives to process the selected transmission packet stream to store in the memory 140.

In this case, if the transmission packet stream exceeding a predetermined amount is stored in the memory 140, the wireless transmitting/receiving unit 150 reads the transmission packet stream stored in the memory 140 and then transmits the read transmission packet stream by wireless.

Thereafter, the wireless transmitting/receiving unit 230 of the display device 200 receives the transmission packet stream transmitted by wireless through the wireless transmitting/receiving unit 150 of the stream source device to store in the memory 240.

In this case, once the transmission packet stream exceeding a predetermined amount is stored in the memory 240, the transmission packet stream processing unit 250 reads the transmission packet stream stored in the memory 240 to output to the decoder 260.

The decoder 260 then decodes the transmission packet stream inputted from the transmission packet stream processing unit 250 to separate into a video signal and an audio signal to output.

In this case, the video processor 270 processes to output the video signal outputted from the decoder 260, thereby displaying an image on a screen through a video output means such as PDP or the like. And, the audio processor 280 processes to output the audio signal outputted from the decoder 260, thereby outputting an audio through an audio output means such as a speaker or the like.

Meanwhile, when a user presses a predetermined key of a remote control transmitter(i.e., remote controller, etc.)(not shown in the drawings) to control an operation of the stream source device 100 or the display device 200, the remote control transmitter generates to transmit a predetermined remote control signal.

The remote control receiving unit 220 then receives to input the transmitted remote control signal to the central processing unit 210.

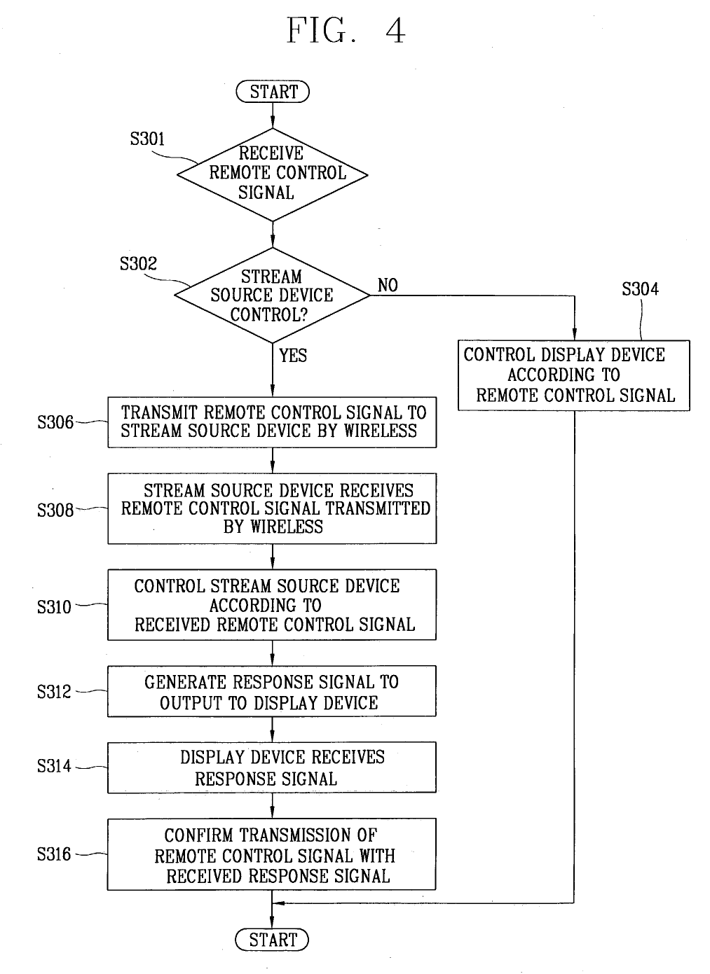

Thereafter, the central processing unit 210 receives the remote control signal from the remote control receiving unit 220 to carry out a predetermined control operation demanded by the user, which is explained in FIG. 4 as follows.

FIG. 4 illustrates a signal flowchart of operating a central processing unit built in a display device according to the present invention.

Referring to FIG. 4, a method of operating a central processing unit includes a judging step of judging whether a remote control signal inputted to a display device in accordance with a user's remote controller operation is a signal of controlling an operation of a stream source device or the display device, a performing step of having the display device carry out a corresponding operation according to the inputted remote control signal if the judging step judges that the remote control signal is the signal of controlling the operation of the display device, a transmitting step of having the display device transmit the remote control signal by wireless to the stream source device if the judging step judges that the remote control signal is the signal of controlling the operation of the stream source device, and a step of having the stream source device receive the transmitted remote control signal to carry out the corresponding operation.

A method of operating a central processing unit built in a display device according to the present invention is explained in detail by referring to the attached drawings as follows.

First of all, a central processing unit 210 receives an input of a corresponding remote control signal according to a user's remote controller operation (S301), and judges whether the inputted remote control signal is a signal of controlling an operation of a stream source device 100 (S302).

As a result of the judgment step S302, if the remote control signal is not the signal of controlling the operation of the stream source device 100 but the signal of controlling the operation of the display device 200, the central processing unit 210 controls the operation of the display device 200 according to the remote control signal to carry out a user-demanding predetermined operation (S304).

Meanwhile, as a result of the judgment step S302, if the remote control signal is the signal of controlling the operation of the stream source device 100, the central processing unit 210 transmits the inputted remote control signal to the stream source device 100 by wireless through a wireless transmitting/receiving unit 230 (S306)

A wireless transmitting/receiving unit 140 of the stream source device 100 receives the transmitted remote control signal (S308), and then inputs the received remote control signal to the central processing unit 110. Thereafter, the central processing unit 110 of the stream source device 100 controls the stream source device 100 according to the received remote control signal to carry out the user-demanding predetermined operation (S310).

In this case, through the remote control signal according to the user's remote controller operation, a transmission packet stream generating unit 120 receives at least one of transmission packet streams from a digital broadcast receiving unit 121, a digital signal receiving unit 122, and an analog signal receiving unit 123, selects one of the transmission packet streams, and then outputs the selected transmission packet stream to a transmission packet stream processing unit 130. And, the subsequent operations are shown in FIG. 2.

In other words, the remote control signal generated according to the user's remote controller operation includes a channel switching signal for switching a channel of the stream source device 100, an output choosing signal for choosing an output of the stream source device 100, an on/off signal for turning on/off a power of the stream source device, and the like. Hence, the user enables to control both of the stream source and display devices 100 and 200 using a single remote controller.

As mentioned in the foregoing description, the remote control signal generated according to the remote controller operation includes various control signals for performing functions used in a general remote controller as well as the channel switching, output choosing, and on/off signals, thereby enabling to carry out the various functions according to the various control signals.

Subsequently, the central processing unit 110 generates a response signal according to a reception of the remote control signal, i.e. a signal for informing that the remote control signal is normally received to carry out the corresponding operation, and then transmits the generated response signal to the stream source device 200 by wireless through the wireless transmitting/receiving unit 140 (S312).

The response signal transmitted by wireless is received by the wireless transmitting/receiving unit of the display device 200 (S314) and is then inputted to the central processing unit 210. Thereafter, through the inputted response signal, the central processing unit 210 confirms that the corresponding remote control signal according to the user's remote controller operation is normally transmitted to the stream source device 100 and that the user-demanding predetermined operation is normally carried out (S316).

Thereafter, a series of operation of the central processing unit 210 for carrying out the user-demanding predetermined control operation by receiving the received remote control signal from the remote control receiving unit 220 is ended.

Meanwhile, the present invention uses the set-top box as the stream source device 100.

Yet, the stream source device 100 is not limited to the set-top box but can be applied to various digital and analog equipments such as DVD players, digital and analog VTRs, computer systems, and the like.

Accordingly, in the present invention, the stream source device transforms the video and audio signals into the transmission packet stream form to transmit to the display device by wireless, the display device receives the transmission packet stream transmitted by wireless, and the stream source and display devices transmit the predetermined control signals reciprocally.

Therefore, the present invention needs no additional cables to transmit various video, audio, and various control signals between the stream source and display devices, thereby enabling to overcome the problem of defiling the appearance of the cables exposed on the wall.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An interface system for a stream source device and a display device, comprising:
a stream source device receiving analog/digital signals from external analog/digital equipments to generate a transmission packet stream corresponding to the analog/digital signal and transmitting the transmission packet stream by wireless; and
a display device receiving the transmission packet stream transmitted from the stream source device 100, the display device decoding the transmission packet stream to separate into a video signal and an audio signal to output respectively.

2. The interface system of claim 1, the stream source device 100 comprising:
a transmission packet stream generating unit receiving a digital broad cast signal, a digital signal, or an analog signal to format into a form of a transmission packet stream to output selectively;
a transmission packet stream processing unit processing the transmission packet stream generated from the transmission packet stream generating unit;
a memory storing the transmission packet stream processed by the transmission packet stream processing unit;
a wireless transmitting/receiving unit reading to transmit the transmission packet stream stored in the memory by wireless; and
a central processing unit controlling a predetermined operation for transmitting the transmission packet stream and operations of. the respective units.

3. The interface system of claim 2, the transmission packet stream generating unit comprising:
a digital broadcast receiving unit receiving the digital broadcast signal from an external antenna to format into the form of the transmission packet stream to output;
a digital signal receiving unit receiving a transmission packet stream corresponding to digital video and audio signals from an external digital equipment;
an analog signal receiving unit receiving analog video and audio signals from an external analog equipment;
an encoder transforming the analog video and audio signals outputted from the analog signal receiving unit into the form of the transmission packet stream and
a multiplexer selectively switching the transmission packet streams outputted from the digital broadcast receiving unit, the digital signal receiving unit, and the encoder according to a control of the central processing unit to output to the transmission packet stream processing unit.

4. The interface system of claim 2, wherein the wireless transmitting/receiving unit receives a remote control signal transmitted by wireless according to a user's operation of a remote controller and outputs the received remote control signal to the central processing unit to carry out a user-demanding predetermined operation.

5. The interface system of claim 2, wherein, if a remote control signal according to a user's operation of a remote controller is a signal for controlling the stream source device, the wireless transmitting/receiving unit receives the remote control signal and receives a response signal corresponding to the remote control signal transmitted from the central processing unit to transmit.

6. The interface system of claim 5, wherein the central processing unit generates the response signal corresponding to the received remote control signal to transmit through the wireless transmitting/receiving unit.

7. The interface system of claim 1, the display device comprising:
a wireless transmitting/receiving unit receiving the transmission packet stream transmitted from the stream source device;
a memory storing the transmission packet stream received from the wireless transmitting/receiving unit;
a transmission packet stream processing unit processing the transmission packet stream stored in the memory;
a decoder decoding the transmission packet stream processed by the transmission packet stream processing unit to separate into a video signal and an audio signal;
a video processor processing to output the video signal separated by the decoder;
an audio processor processing to output the audio signal separated by the decoder; and
a central processing unit controlling a predetermined operation for receiving to process the transmission packet stream.

8. The interface system of claim 7, further comprising a remote control receiving unit receiving a remote control signal according to a user's operation of a remote controller and outputting the received remote control signal to the central processing unit to carry out a user-demanding predetermined operation.

9. A stream source device comprising:
a transmission packet stream generating unit receiving a digital broad cast signal, a digital signal, or an analog signal to format into a form of a transmission packet stream to output selectively;
a transmission packet stream processing unit processing the transmission packet stream generated from the transmission packet stream generating unit;
a memory storing the transmission packet stream processed by the transmission packet stream processing unit;
a wireless transmitting/receiving unit reading to transmit the transmission packet stream stored in the memory by wireless; and
a central processing unit controlling a predetermined operation for transmitting the transmission packet stream and operations of the respective units.

10. The interface system of claim 9, the transmission packet stream generating unit comprising:
a digital broadcast receiving unit receiving the digital broadcast signal from an external antenna to format into the form of the transmission packet stream to output;
a digital signal receiving unit receiving a transmission packet stream corresponding to digital video and audio signals from an external digital equipment;
an analog signal receiving unit receiving analog video and audio signals from an external analog equipment;
an encoder transforming the analog video and audio signals outputted from the analog signal receiving unit into the form of the transmission packet stream; and
a multiplexer selectively switching the transmission packet streams outputted from the digital broadcast receiving unit, the digital signal receiving unit, and the encoder according to a control of the central processing unit to output to the transmission packet stream processing unit.

11. The interface system of claim 9, wherein the wireless transmitting/receiving unit receives a remote control signal transmitted by wireless according to a user's operation of a remote controller and outputs the received remote control signal to the central processing unit to carry out a user-demanding predetermined operation.

12. The interface system of claim 11, wherein the central processing unit generates the response signal corresponding to the received remote control signal to transmit through the wireless transmitting/receiving unit.

13. A display device comprising:
a wireless transmitting/receiving unit receiving a transmission packet stream transmitted from a stream source device;
a memory storing the transmission packet stream received from the wireless transmitting/receiving unit;
a transmission packet stream processing unit processing the transmission packet stream stored in the memory;
a decoder decoding the transmission packet stream processed by the transmission packet stream processing unit to separate into a video signal and an audio signal;
a video processor processing to output the video signal separated by the decoder;
an audio processor processing to output the audio signal separated by the decoder; and
a central processing unit controlling a predetermined operation for receiving to process the transmission packet stream.

14. The interface system of claim 13, further comprising a remote control receiving unit receiving a remote control signal according to a user's operation of a remote controller and outputting the received remote control signal to the central processing unit to carry out a user-demanding predetermined operation.

15. An interfacing method for stream source and display devices, comprising:
a judging step of judging whether a remote control signal inputted to the display device in accordance with a user's remote controller operation is a signal for controlling an operation of the stream source device or the display device;
a performing step of having the display device carry out a corresponding operation according to the inputted remote control signal if the judging step judges that the remote control signal is the signal for controlling the operation of the display device;
a transmitting step of having the display device transmit the inputted remote control signal by wireless to the stream source device if the judging step judges that the remote control signal is the signal of controlling the operation of the stream source device; and
a step of having the stream source device receive the remote control signal transmitted by wireless to carry out a corresponding operation.

16. The method of claim 15, further comprising a step of having the stream source device carry out the operation according to the remote control signal transmitted by wireless and having the stream source device generate a response signal for informing that the remote control signal is normally received to transmit to the display device by wireless.
